(19) United States
(12) Patent Application Publication
(10) Pub. No.: US 2013/0260604 A1
(43) Pub. Date: Oct. 3, 2013

(54) MOUNTING DEVICE FOR CONNECTOR

(71) Applicants: HONG FU JIN PRECISION INDUSTRY (Shenzhen) CO., LTD., (US); HON HAI PRECISION INDUSTRY CO., LTD., New Taipei (TW)

(72) Inventors: YU-WEI HE, Shenzhen (CN); XIU-QUAN HU, Shenzhen (CN); SHANG-NONG FAN, Shenzhen (CN)

(73) Assignees: HON HAI PRECISION INDUSTRY CO., LTD., New Taipei (TW); HONG FU JIN PRECISION INDUSTRY (Shenzhen) CO., LTD, Shenzhen (CN)

(21) Appl. No.: 13/718,492

(22) Filed: Dec. 18, 2012

(30) Foreign Application Priority Data
Apr. 3, 2012 (CN) 201210095714.6

(51) Int. Cl. H01R 13/73

(52) U.S. Cl. CPC H01R 13/73
USPC 439/527

(57) ABSTRACT

A mounting device includes a chassis and a bracket. The bracket is removably mounted in the chassis and includes a bottom wall and two sidewalls connected to the bottom wall. The two sidewalls are configured for receiving a connector therebetween. The bottom wall defines a first limiting slot for receiving a first blocking piece extending from a first outer surface of the connector, to prevent the connector from moving along a first direction substantially parallel to the bottom wall. The bracket further includes two elastically deformable hooks extending from the two sidewalls, and the two elastically deformable hooks are configured for abutting the connector between the two elastically deformable hooks and the bottom wall, to prevent the connector from moving along a second direction substantially perpendicular to the bottom wall.

### BACKGROUND

1. Technical Field

The present disclosure relates to mounting devices, particularly to a mounting device for a connector.

2. Description of Related Art

A number of thick cables is used in electronic devices, such as servers. Generally, each cable is connected to a connector, and the connector is connected to a corresponding connector in a main board. However, the connector comes loose easily from the corresponding connector.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a mounting device and a connector in accordance with an embodiment.

FIG. 2 is similar to FIG. 1, but viewed from a different aspect.

FIG. 3 is an assembled, isometric view of the mounting device of FIG. 1.

FIG. 4 is similar to FIG. 3, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

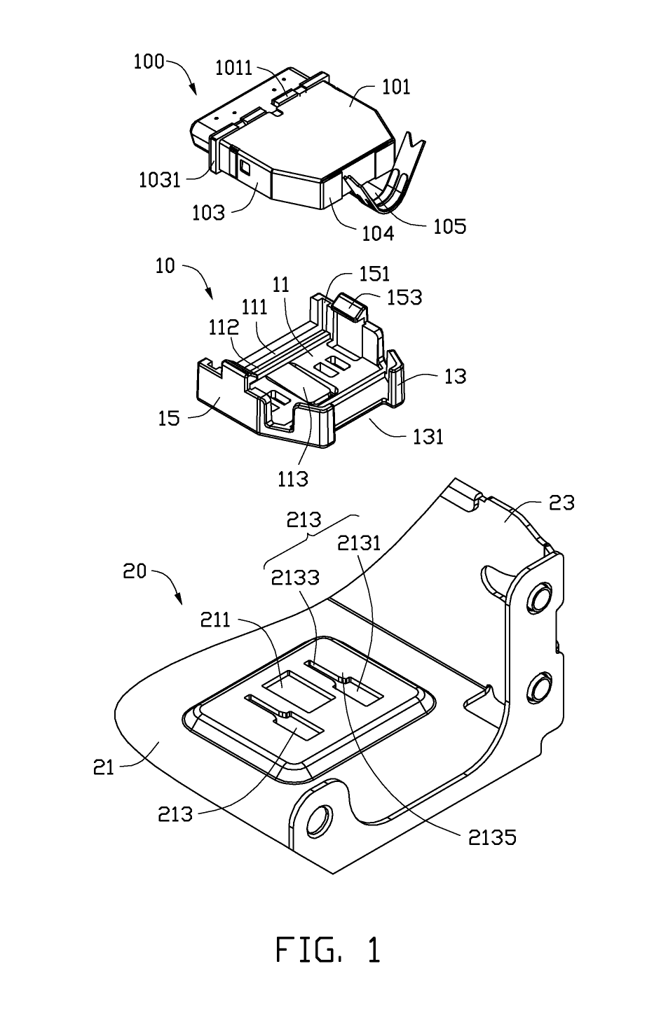

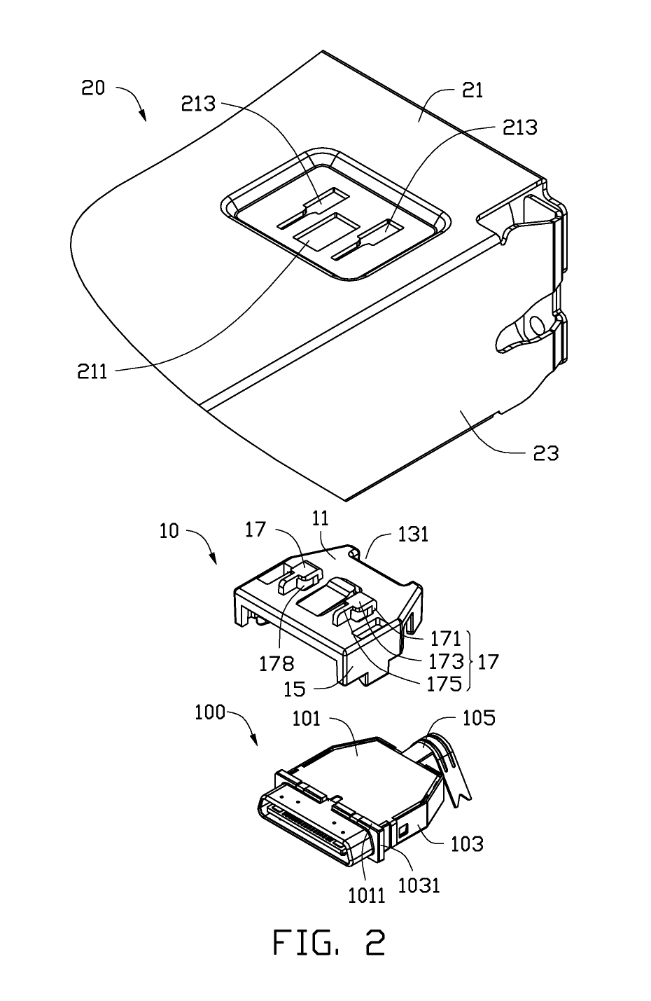

FIG. 1 and FIG. 2 illustrate a mounting device for a connector 100 in accordance with an embodiment. The mounting device comprises a bracket 10 and a chassis 20.

The connector 100 comprises two horizontal surfaces 101, two side surfaces 103, and a rear surface 104. A plurality of cables 105 extends out of the rear surface 104. A first blocking piece 1011 extends from each of the two horizontal surfaces 101. A second blocking piece 1031 extends from each of the two side surfaces 103. The first blocking piece 1011 is substantially perpendicular to the second blocking piece 1031. The first blocking piece 1011 and the second blocking piece 1031 prevent the connector 100 from being over inserted into the corresponding connector.

The bracket 10 comprises a bottom wall 11, a rear wall 13, and two sidewalls 15 connected to the bottom wall 11 and the rear wall 13. In one embodiment, the bottom wall 11 is substantially perpendicular to the rear wall 13 and the two sidewalls 15, and the two sidewalls 15 are parallel to each other. Two ribs 111 extend from the bottom wall 11. A first limiting slot 112 is defined between the two ribs 111. Each of the two sidewalls 15 defines a second limiting slot 151. The first limiting slot 112 is substantially perpendicular to the second limiting slot 151. A resilient piece 171 obliquely extends downwards from the bottom wall 11. Two mounting portions 17 extend from a bottom surface of the bottom wall 11. Each mounting portion 17 comprises a resisting piece 171, a limiting piece 173, and a positioning piece 175. The resisting piece 171 and the positioning piece 175 extend from the bottom wall 11. In one embodiment, the resisting piece 171 and the positioning piece 175 are substantially perpendicular to the bottom wall 11, the resisting piece 171 is substantially perpendicular to the positioning piece 175, and the limiting piece 173 is substantially parallel to the bottom wall 11. The limiting piece 173 connects the resisting piece 171 to the positioning piece 175. A gap 178 is defined between the limiting piece 173 and the bottom wall 11. A hook 153 extends from each of the two sidewalls 15. A distance between the two sidewalls 15 is substantially equal to a distance between the two side surfaces 103. The rear wall 13 defines a cutout 131 for receiving the cable 105.

The chassis 20 comprises a bottom plate 21 and a side plate 23. In one embodiment, the bottom plate 21 is substantially perpendicular to the side plate 23. The bottom plate 21 is used for securing a motherboard (not shown). The bottom plate 21 defines an opening 211 and two mounting slots 213. The opening 211 is located between the two mounting slots 213. Each mounting slot 213 comprises a guiding end 2131 and a mounting end 2133 communicated with the guiding end 2131. A width of the guiding end 2131 is greater than a width of the mounting end 2133, so as to form two mounting extensions 2135 on two opposite sides of the mounting end 2133.

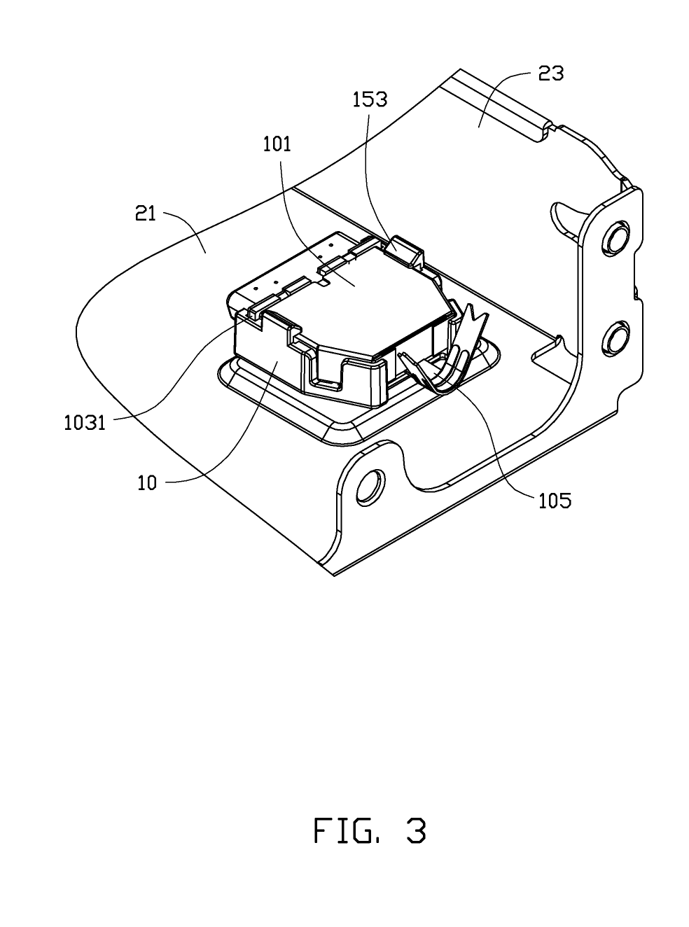

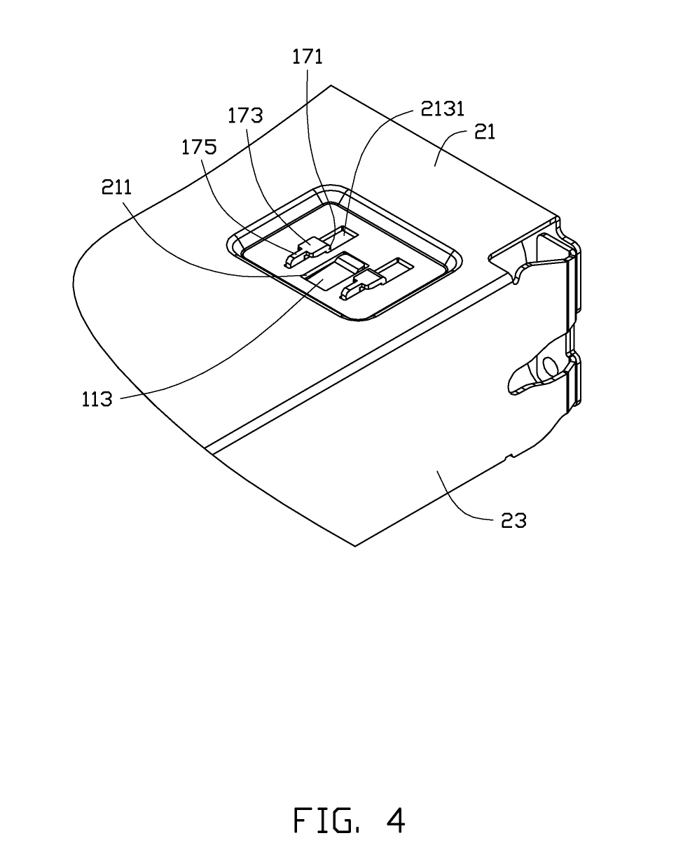

FIG. 3 and FIG. 4 show that, in assembly, the connector 100 is moved to be adjacent to the bracket 10, and the second blocking piece 1031 is aligned with the second limiting slot 151. The second blocking piece 1031 slides into the second limiting slot 151. The connector 100 is pressed towards the bottom wall 11 to elastically deform the two hooks 153, and then received in the bracket 10. The hooks 153 rebound to abut the horizontal surface 101, to prevent the connector 100 from moving along a first direction that is substantially perpendicular to the bottom wall 11. The rear surface 104 abuts the rear wall 13, and the cable 105 extends out of the cutout 131. The first blocking piece 1011 is received in the first limiting slot 112, and the second blocking piece 1031 is received in the second limiting slot 151, to prevent the connector 100 from moving along a second direction substantially parallel to the bottom wall 11. Thus, the connector 100 is secured to the bracket 10.

The bracket 10 is moved to be adjacent to the bottom plate 21, and the limiting piece 173 and the resisting piece 171 are inserted into the guiding end 2131. The resilient piece 113 is elastically deformed upwards by the bottom plate 21. The bracket 10 is slid towards the mounting end 2133, until the positioning piece 175 is blocked by an edge of the mounting end 2133. In this position, the resilient piece 113 is aligned with the opening 211, and the mounting extension 2135 abuts the resisting piece 171. The resilient piece 113 rebounds to be received in the opening 211. The mounting extension 2135 is received in the gap 178 and sandwiched between the mounting portion 17 and the bottom wall 11.

In disassembly, the bracket 10 is pressed to elastically deform the resilient piece 113, so that the resilient piece 113 is disengaged from the opening 211. The bracket 10 is slid towards the guiding end 2131, and then the bracket 10 can be removed from the chassis 20. The hooks 153 are elastically deformed outwards, and the connector 100 can be removed from the bracket 10.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A mounting device comprising:
a chassis; and
a bracket removably mounted in the chassis and comprising a bottom wall and two sidewalls connected to the bottom wall; and the two sidewalls being configured for receiving a connector therebetween;
wherein the bottom wall defines a first limiting slot for receiving a first blocking piece extending from a first outer surface of the connector, to prevent the connector from moving along a first direction substantially parallel to the bottom wall; the bracket further comprises two elastically deformable hooks extending from the two sidewalls, and the two elastically deformable hooks are configured for abutting the connector between the two elastically deformable hooks and the bottom wall, to prevent the connector from moving along a second direction substantially perpendicular to the bottom wall.

2. The mounting device of claim 1, wherein each of the two sidewalls is substantially perpendicular to the bottom wall; each of the two sidewalls defines a second limiting slot for receiving a second blocking piece extending from a second outer surface of the connector adjacent to the first outer surface; and the first limiting slot communicates with the second limiting slot and is substantially perpendicular to the second limiting slot.

3. The mounting device of claim 1, wherein the chassis comprises a bottom plate; the bracket further comprises a resilient piece extending from the bottom wall; the bracket is secured to the bottom plate; and the bottom plate defines an opening, and the resilient piece is received in the opening.

4. The mounting device of claim 3, wherein the resilient piece extends obliquely from the bottom wall.

5. The mounting device of claim 3, wherein the bottom plate defines a mounting slot, the bracket further comprises a mounting portion extending from the bottom wall, and the mounting portion and the two elastically deformable hooks extend from two opposite surface of the bottom wall; and the mounting portion is slidably mounted to the mounting slot.

6. The mounting device of claim 5, wherein the mounting portion comprises a resisting piece, a limiting piece, and a positioning piece; the mounting slot comprises a guiding end and a mounting end communicating with the guiding end, and a width of the mounting end is smaller than a width of the guiding end; the resisting piece and the limiting piece are engaged in the mounting slot; and the positioning piece is engaged in the mounting end.

7. The mounting device of claim 6, wherein the bottom plate further comprises two mounting extensions on two opposite sides of the mounting end; a gap is defined between the limiting piece and the bottom wall; and the two mounting extensions are received in the gap.

8. The mounting device of claim 7, wherein the resisting piece and the positioning piece are substantially perpendicular to the bottom wall, the resisting piece is substantially perpendicular to the positioning piece, and the two mounting extensions abuts the resisting piece.

9. The mounting device of claim 6, wherein the resisting piece and the positioning piece extend from the bottom wall, and the limiting piece connects the resisting piece to the positioning piece.

10. The mounting device of claim 6, wherein the limiting piece is substantially parallel to the bottom wall.

11. A mounting device comprising:
a chassis comprising a bottom plate defining a mounting slot; and
a bracket comprising a bottom wall, two sidewalls connected to the bottom wall, two elastically deformable hooks extending from top edges of the two sidewalls, and a mounting portion extending from the bottom wall; and the two sidewalls being configured for receiving a connector therebetween;
wherein the mounting portion is slidably engaged in the mounting slot; the bottom wall defines a first limiting slot for receiving a first blocking piece extending from a first outer surface of the connector, to prevent the connector from moving along a first direction substantially parallel to the bottom wall; and the two elastically deformable hooks are configured for abutting the connector between the two elastically deformable hooks and the bottom wall, to prevent the connector from moving along a second direction substantially perpendicular to the bottom wall.

12. The mounting device of claim 11, wherein each of the two sidewalls is substantially perpendicular to the bottom wall; each of the two sidewalls defines a second limiting slot for receiving a second blocking piece extending from a second outer surface of the connector adjacent to the first outer surface; and the first limiting slot communicates with the second limiting slot and is substantially perpendicular to the second limiting slot.

13. The mounting device of claim 11, wherein the bracket further comprises a resilient piece extending from the bottom wall, the bottom plate defines an opening, and the resilient piece is received in the opening to prevent the mounting portion from sliding along the mounting slot.

14. The mounting device of claim 13, wherein the resilient piece extends obliquely from the bottom wall.

15. The mounting device of claim 11, wherein the mounting portion and the two elastically deformable hooks extend from two opposite surface of the bottom wall.

16. The mounting device of claim 11, wherein the mounting portion comprises a resisting piece, a limiting piece, and a positioning piece; the mounting slot comprises a guiding end and a mounting end communicating with the guiding end, and a width of the mounting end is smaller than a width of the guiding end; the resisting piece and the limiting piece are engaged in the mounting slot; and the positioning piece is engaged in the mounting end.

17. The mounting device of claim 16, wherein the bottom plate further comprises two mounting extensions on two opposite sides of the mounting end; a gap is defined between the limiting piece and the bottom wall; and the two mounting extensions are received in the gap.

18. The mounting device of claim 17, wherein the resisting piece and the positioning piece are substantially perpendicular to the bottom wall, the resisting piece is substantially perpendicular to the positioning piece, and the two mounting extensions abuts the resisting piece.

19. The mounting device of claim 16, wherein the resisting piece and the positioning piece extending from the bottom wall, and the limiting piece connects the resisting piece to the positioning piece.

20. The mounting device of claim 16, wherein the limiting piece is substantially parallel to the bottom wall.
